(19) United States
(12) Patent Application Publication
(10) Pub. No.: US 2014/0078394 A1
(43) Pub. Date: Mar. 20, 2014

(54) SELECTIVE USE OF CHROMA INTERPOLATION FILTERS IN LUMA INTERPOLATION PROCESS

(71) Applicant: GENERAL INSTRUMENT CORPORATION, Horsham, PA (US)

(72) Inventors: Jian Lou, San Diego, CA (US); Koohyar Minoo, San Diego, CA (US); Limin Wang, San Diego, CA (US); Yue Yu, San Diego, CA (US)

(73) Assignee: GENERAL INSTRUMENT CORPORATION, Horsham, PA (US)

(21) Appl. No.: 13/830,855

(22) Filed: Mar. 14, 2013

Related U.S. Application Data
(60) Provisional application No. 61/702,190, filed on Sep. 17, 2012.
(60) Provisional application No. 61/703,811, filed on Sep. 21, 2012.

(51) Int. Cl. H04N 11/20

(52) U.S. Cl. CPC H04N 11/20
USPC 348/453

(57) ABSTRACT

In one embodiment, a method determines one or more luma interpolation filters for interpolating sub-pel pixel values for a luma component. The one or more luma interpolation filters have a first number of coefficients. Then, the method determines one or more chroma interpolation filters for interpolating sub-pel pixel values for a chroma component. The one or more chroma interpolation filters have a second number of coefficients where the second number of coefficients is less than the first number of coefficients. When the one or more chroma interpolation filters should be used to interpolate a sub-pel pixel value for the luma component, the method uses a chroma interpolation filter to interpolate a sub-pixel value for the luma component by applying coefficients of the chroma interpolation filter to corresponding pixel values for the luma component.

### CROSS REFERENCE TO RELATED APPLICATIONS

The present application claims priority to U.S. Provisional App. No. 61/702,190 for “High level syntax supporting using Chroma interpolation filter(s) for Luma interpolation” filed Sep. 17, 2012 and U.S. Provisional App. No. 61/703,811 for “High level syntax supporting using Chroma interpolation filter(s) for Luma interpolation” filed Sep. 21, 2012, the contents of all of which are incorporated herein by reference in their entirety.

### BACKGROUND

Video compression systems employ block processing for most of the compression operations. A block is a group of neighboring pixels and may be treated as one coding unit in terms of the compression operations. Theoretically, a larger coding unit is preferred to take advantage of correlation among immediate neighboring pixels. Various video compression standards, e.g., Motion Picture Expert Group (MPEG)-1, MPEG-2, and MPEG-4, use block sizes of 4×4, 8×8, and 16×16 (referred to as a macroblock (MB)).

High-efficiency video coding (HEVC) is a block-based hybrid spatial and temporal predictive coding scheme. Similar to other video coding standards, HEVC supports intra-picture, such as I picture, and inter-picture, such as B and P pictures. Intra-picture is coded without referring to any other pictures. Thus, only spatial prediction is allowed for a coding unit (CU)/prediction unit (PU) inside an intra-picture. Inter-picture, however, supports both intra- and inter-prediction. A CU/PU in an inter-picture may be either spatially or temporally predictive coded. Temporal predictive coding may reference pictures that were previously coded.

Temporal motion prediction is an effective method to increase the coding efficiency and provides high compression. HEVC uses a translational model for motion prediction. According to the translational model, a prediction signal for a given block in a current picture is generated from a corresponding block in a reference picture. The coordinates of the reference block are given by a motion vector that describes the translational motion along horizontal (x) and vertical (y) directions that would be added/subtracted to/from the coordinates of the current block. A decoder needs the motion vector to decode the compressed video.

The pixels in the reference frame are used as the prediction. In one example, the motion may be captured in integer pixels. However, not all objects move with the spacing of integer pixels (pixels are also referred to as pel). For example, since an object motion is completely unrelated to the sampling grid, sometimes the object motion is more like sub-pel (fractional) motion than a full-pel one. Thus, HEVC allows for motion vectors with sub-pel accuracy.

In order to estimate and compensate sub-pel displacements, the image signal on these sub-pel positions is generated by an interpolation process. In HEVC, sub-pel interpolation is performed using finite impulse response (FIR) filters. Generally, the filter may have taps to determine the sub-pel values for sub-pel positions, such as half-pel, quarter-pel, and one-eighth pel positions. The taps of an interpolation filter weight the integer pixels with coefficient values to generate the sub-pel signals. Different coefficients may produce different compression performance in signal distortion and noise.

Each pixel may include luma and chroma components. Chroma may be the intensity of the color for the pixel and luma may be the brightness of the pixel. In general, different interpolation filters are used for the luma component and chroma component, respectively. For example, a longer interpolation filter (e.g., additional taps/coefficients) is used for a luma component interpolation process than an interpolation filter for a chroma component interpolation process. That is, the interpolation filter for the chroma component includes fewer taps/coefficients. One reason for using less taps/coefficients is that a human visual system is less sensitive to the chroma component (e.g., color differences) than the luma component (e.g., brightness). The use of fewer taps/coefficients in interpolating sub-pixel values may result in less compression efficiency, which may result in an image with respect to the chroma component with less high frequency information. However, due to the lowered human visual system's sensitivity to the chroma component, the resulting less high frequency information that may result with using shorter interpolation filters for the chroma component may not be noticeable.

### BRIEF DESCRIPTION OF THE DRAWINGS

FIG. 1 depicts an example of a system for encoding and decoding video content according to one embodiment.

FIG. 2 depicts an example of luma sub-pel pixel positions according to one embodiment.

FIG. 3 depicts an example of chroma sub-pel pixel positions according to one embodiment.

FIG. 4 depicts an example of a syntax according to one embodiment.

FIG. 5A depicts a more detailed example of an encoder or a decoder according to one embodiment.

FIG. 5B depicts another example of the encoder or the decoder for the determination of which interpolation filters to use for the luma interpolation process according to one embodiment.

FIG. 6 depicts a simplified flowchart of a method for determining an interpolation filter 106 during an encoding process according to one embodiment.

FIG. 7 depicts a simplified flowchart for determining an interpolation filter during a decoding process according to one embodiment.

FIG. 8A depicts an example of an encoder according to one embodiment.

FIG. 8B depicts an example of a decoder according to one embodiment.

### DETAILED DESCRIPTION

Described herein are techniques for a video compression system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

In one embodiment, a method determines one or more luma interpolation filters for interpolating sub-pel pixel values for a luma component. The one or more luma interpolation filters have a first number of coefficients. Then, the method determines one or more chroma interpolation filters for interpolating sub-pel pixel values for a chroma component. The one or more chroma interpolation filters have a second number of coefficients where the second number of coefficients is less than the first number of coefficients. When the one or more chroma interpolation filters should be used to interpolate a sub-pel pixel value for the luma component, the method uses a chroma interpolation filter to interpolate a sub-pixel value for the luma component by applying coefficients of the chroma interpolation filter to corresponding pixel values for the luma component.

In one embodiment, an encoder includes: one or more computer processors; and a non-transitory computer-readable storage medium comprising instructions, that when executed, control the one or more computer processors to be configured for: determining one or more luma interpolation filters for interpolating sub-pel pixel values for a luma component, the one or more luma interpolation filters having a first number of coefficients; determining one or more chroma interpolation filters for interpolating sub-pel pixel values for a chroma component, the one or more chroma interpolation filters having a second number of coefficients, wherein the second number of coefficients is less than the first number of coefficients; determining when the one or more chroma interpolation filters should be used to interpolate a sub-pel pixel value for the luma component; and when the one or more chroma interpolation filters should be used to interpolate the sub-pixel value for the luma component, using a chroma interpolation filter to interpolate a sub-pixel value for the luma component by applying coefficients of the chroma interpolation filter to corresponding pixel values for the luma component; and encoding a unit of video using the sub-pel pixel value for the luma component.

In one embodiment, a decoder includes: one or more computer processors; and a non-transitory computer-readable storage medium comprising instructions, that when executed, control the one or more computer processors to be configured for: receiving an encoded bitstream; determining one or more luma interpolation filters for interpolating sub-pel pixel values for a luma component, the one or more luma interpolation filters having a first number of coefficients; determining one or more chroma interpolation filters for interpolating sub-pel pixel values for a chroma component, the one or more chroma interpolation filters having a second number of coefficients, wherein the second number of coefficients is less than the first number of coefficients; determining when the one or more chroma interpolation filters should be used to interpolate a sub-pel pixel value for the luma component; when the one or more chroma interpolation filters should be used to interpolate the sub-pixel value for the luma component, using a chroma interpolation filter to interpolate a sub-pixel value for the luma component by applying coefficients of the chroma interpolation filter to corresponding pixel values for the luma component; and decoding a unit of video in the encoded bitstream using the sub-pel pixel value for the luma component.

### Overview

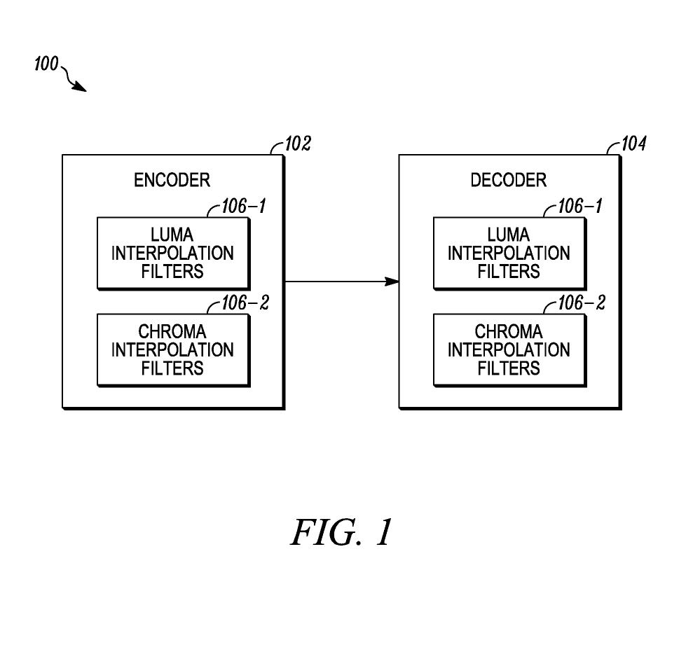

FIG. 1 depicts an example of a system 100 for encoding and decoding video content according to one embodiment. System 100 includes an encoder 102 and a decoder 104, both of which will be described in more detail below. Encoder 102 and decoder 104 perform temporal prediction through motion estimation and motion compensation. Motion estimation is a process of determining a motion vector (MV) for a current unit of video, which may be a block of pixels. Motion compensation is applying the motion vector to the current unit. For example, the temporal prediction searches for a best match prediction for a current prediction unit (PU) over reference pictures. The best match prediction is described by the motion vector and associated reference picture ID. Also, a PU in a B picture may have up to two motion vectors, and a PU in a P picture may have one motion vector. Although a PU is described, other units of video may be used.

The temporal prediction allows for fractional (sub-pel) picture accuracy. Sub-pel prediction is used because motion during two instances of time (the current picture and reference picture capture times) can correspond to a sub-pel position in pixel coordinates and generation of different prediction data corresponding to each sub-pel position allows for the possibility of conditioning the prediction signal to better match the signal in the current PU.

Interpolation filters, such as FIR filters, include taps that weight full-pel pixel values with coefficient values that are used to determine the sub-pel pixel values for different sub-pel pixel positions in a picture. When a different interpolation filter is used, the interpolation filter may use different values for coefficients and/or a different number of taps.

To calculate the sub-pel pixel values, encoder 102 and decoder 104 use a weighted sum of integer pixels. In one embodiment, encoder 102 and decoder 104 use integer values as weighting factors and apply a right shift to save computational complexity with an added shift offset. Encoder 102 and decoder 104 may also apply a clipping operation to keep the interpolated sub-pel pixel values within a normal dynamic range.

Encoder 102 and decoder 104 include different interpolation filters for a luma component and a chroma component of video being encoded or decoded. For example, encoder 102 and decoder 104 include a set of luma interpolation filters 106-1 and a set of chroma interpolation filters 106-2. Each set may include one or more luma interpolation filters and one or more chroma interpolation filters, respectively. Each interpolation filter may provide different compression performance and characteristics. Also, interpolation filters in luma interpolation filters 106-1 may include a different number of taps and/or different coefficients from interpolation filters in chroma interpolation filters 106-2.

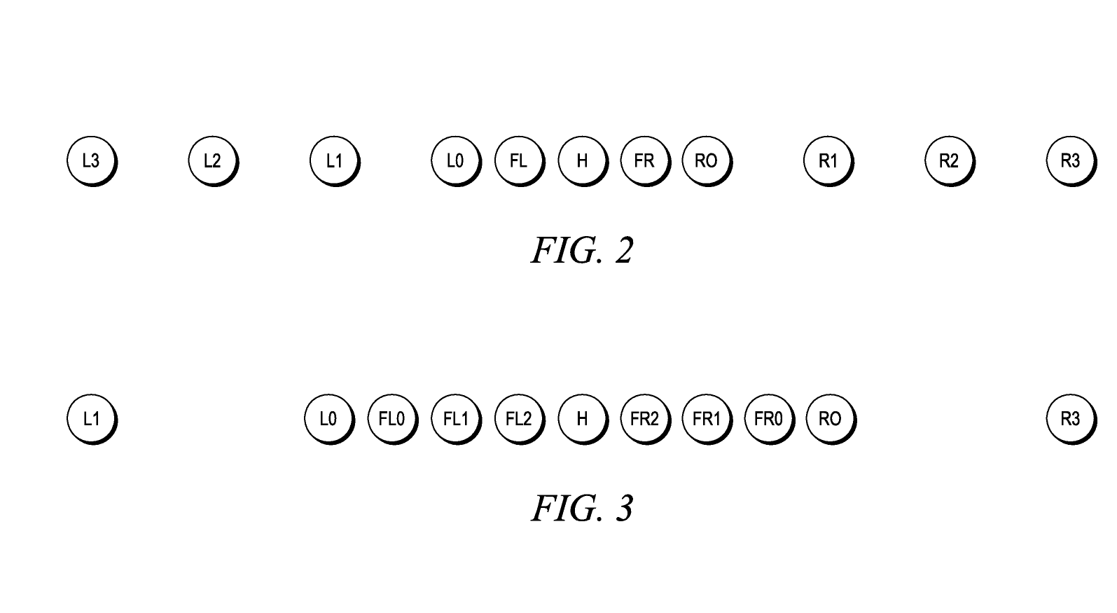

In one embodiment, 8-tap or 7-tap interpolation filters (e.g., finite impulse response (FIR) filters) are used for luma interpolation filters 106-1. The luma sub-pel pixel values are interpolated using the values of spatial neighboring full-pel pixel values. For example, FIG. 2 depicts an example of luma sub-pel pixel positions according to one embodiment. In this example, the positions of half-pel and quarter-pel pixels are between full-pel pixels along a pixel line within a picture. The full-pel pixels are represented as L3, L2, L1, L0, R0, R1, R2, and R3. H is the half-pel pixel that is between full-pel pixels L0 and R0. FL is a quarter-pel pixel between full-pel pixel L0 and half-pel pixel H, and FR is another quarter-pel pixel between half-pel pixel H and full-pel pixel R0. Although half-pel and quarter-pel pixels are described, other sub-pel pixel positions may be appreciated, such as sub-pel pixels that are eighth-pel pixels.

Encoder 102 and decoder 104 interpolate the values of the luma sub-pel pixels FL, H, and FR using the values of the spatially neighboring full-pel pixels, L3, L2, L1, L0, R0, R1, R2, and R3. In this case, luma interpolation filters 106-1 may include 8 coefficients/taps. In certain embodiments, 7 coefficients/taps may also be used to interpolate the same luma sub-pel pixel values FL, H, and FR. In one embodiment, the luma sub-pel pixels FL, H, and FR are calculated as follows:

FL=(−1*L3+4*L2−10*L1+58*L0+17*R0−5*R1+1*R2+0*R3+32)>>6

H=(−1*L3+4*L2−11*L1+40*L0+40*R0−11*R1+4*R2−1*R3+32)>>6

FR=(0*L3+1*L2−5*L1+17*L0+58*R0−10*R1+4*R2−1*R3+32)>>6

Table 1 summarizes the coefficients used in a set of luma interpolation filters 106-1.

TABLE 1
Luma interpolation filter set coefficients

| Position | Coefficients |
|---|---|
| FL | {−1, 4, −10, 58, 17, −5, 1, 0} |
| H | {−1, 4, −11, 40, 40, −11, 4, −1} |
| FR | {0, 1, −5, 17, 58, −10, 4, −1} |

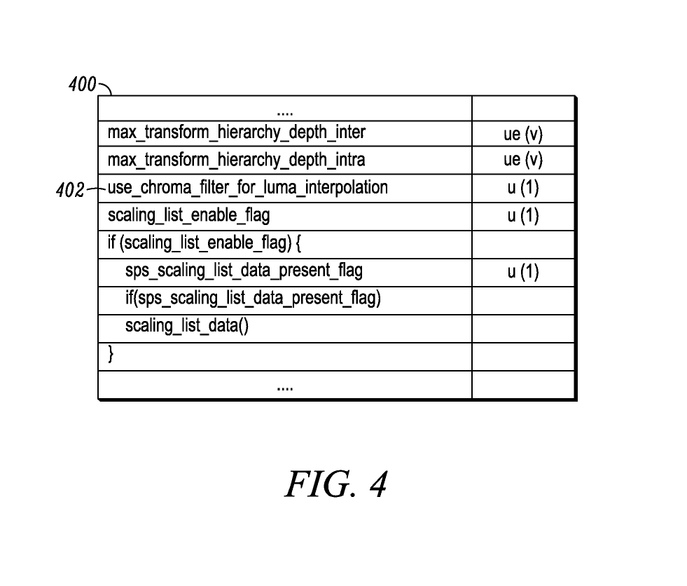

Chroma interpolation filters 106-2 may use less taps/coefficients than luma interpolation filters 106-1. As was discussed above, a human visual system is less sensitive to the chroma component than the luma component. Thus, in one embodiment, 4-tap interpolation filters are used for chroma interpolation filters 106-2. FIG. 3 depicts an example of chroma sub-pel pixel positions according to one embodiment. Half-pel pixel, quarter-pel pixel, and eighth-pel pixel positions are between full-pel pixel positions along a pixel line within a picture. Full-pel pixels include L1, L0, R0, and R1. H is a half-pel pixel between full-pel pixels L0 and R0. FL0, FL1, and FL2 are fractional-pel pixels between full-pel pixel L0 and half-pel pixel H. Also, FR0, FR1, and FR2 are fractional-pel pixels between half-pel pixel H and full-pel pixel R0.

The chroma sub-pel pixels FL0, FL1, FL2, H, FR2, FR1, and FR0 can be interpolated using values of spatial neighboring full-pel pixels L1, L0, R0, and R1. In one embodiment, 4 taps/coefficients are used to perform the interpolation as follows:

FL0=(−2*L1+58*L0+10*R0−2*R1+32)>>6

FL1=(−4*L1+54*L0+16*R0−2*R1+32)>>6

FL2=(−6*L1+46*L0+28*R0−4*R1+32)>>6

H=(−4*L1+36*L0+36*R0−4*R1+32)>>6

FR2=(−4*L1+28*L0+46*R0−6*R1+32)>>6

FR1=(−2*L1+16*L0+54*R0−4*R1+32)>>6

FR0=(−2*L1+10*L0+58*R0−2*R1+32)>>6

Table 2 summarizes the filter coefficients used in the set of chroma interpolation filters 106-2.

TABLE 2
Chroma interpolation filter set coefficient

| Position | Coefficients |
|---|---|
| FL0 | {−2, 58, 10, −2} |
| FL1 | {−4, 54, 16, −2} |
| FL2 | {−6, 46, 28, −4} |
| H | {−4, 36, 36, −4} |
| FR2 | {−4, 28, 46, −6} |
| FR1 | {−2, 16, 54, −4} |
| FR0 | {−2, 10, 58, −2} |

In general, longer interpolation filters (filters with more taps/coefficients) achieve a higher compression efficiency than shorter interpolation filters. The higher compression efficiency may result in a picture with more high frequency information when reconstructed from the encoded bitstream. High frequency information may result when more abrupt difference occur in an image. However, on the other hand, shorter interpolation filters may reduce the memory bandwidth for motion estimation and motion compensation. Also, the computational complexity may be reduced using shorter interpolation filters. Due to the higher human visual sensitivity to the luma component and different characteristics of luma and chroma component (e.g., chroma usually has less high frequency information), longer interpolation filters for the luma component are generally used as compared to interpolation filters for the chroma component. However, even though traditionally longer interpolation filters were used for the luma component of video, particular embodiments provide the flexibility to switch between longer interpolation filters designed for the luma interpolation process and shorter interpolation filters designed for the chroma interpolation process. For example, if 8-tap interpolation filters and 4-tap interpolation filters are being used for the luma component and the chroma component, respectively, particular embodiments provide the flexibility to switch between the 8-tap interpolation filters and the 4-tap interpolation filters in the luma interpolation process. Specifically, if 8-tap interpolation filters are being used for luma interpolation filters 106-1, particular embodiments provide the flexibility to use chroma interpolation filters 106-2 (e.g., 4-tap interpolation filters) for interpolating the luma component. For example, when interpolating a luma component sub-pel pixel value, chroma interpolation filters 106-2 are used. In one embodiment, no additional interpolation filters are used other than that defined for luma interpolation or chroma interpolation, which introduces minimal additional complexity. That is, only a way to switch between luma interpolation filters 106-1 and chroma interpolation filters 106-2 is needed, and additional interpolation filters do not need to be defined. However, in other embodiments, additional interpolation filters may be introduced and selectively used in the luma interpolation process. Also, although using chroma interpolation filters 106-2 in the luma interpolation process is discussed, particular embodiments may also use luma interpolation filters 106-1 in the chroma interpolation process.

Although shorter interpolation filters (e.g., chroma interpolation filters 106-2) have lower compression efficiency than longer interpolation filters (e.g., luma interpolation filters 106-1), this may not always be true. In some cases, shorter interpolation filters may achieve higher compression efficiency than longer interpolation filters. Also, in some cases, the performance loss from shorter interpolation filters may be negligible or not noticeable to human visual systems. Thus, shorter interpolation filters may achieve a reduction in memory bandwidth for motion estimation and motion compensation and computational complexity without a noticeable loss in performance.

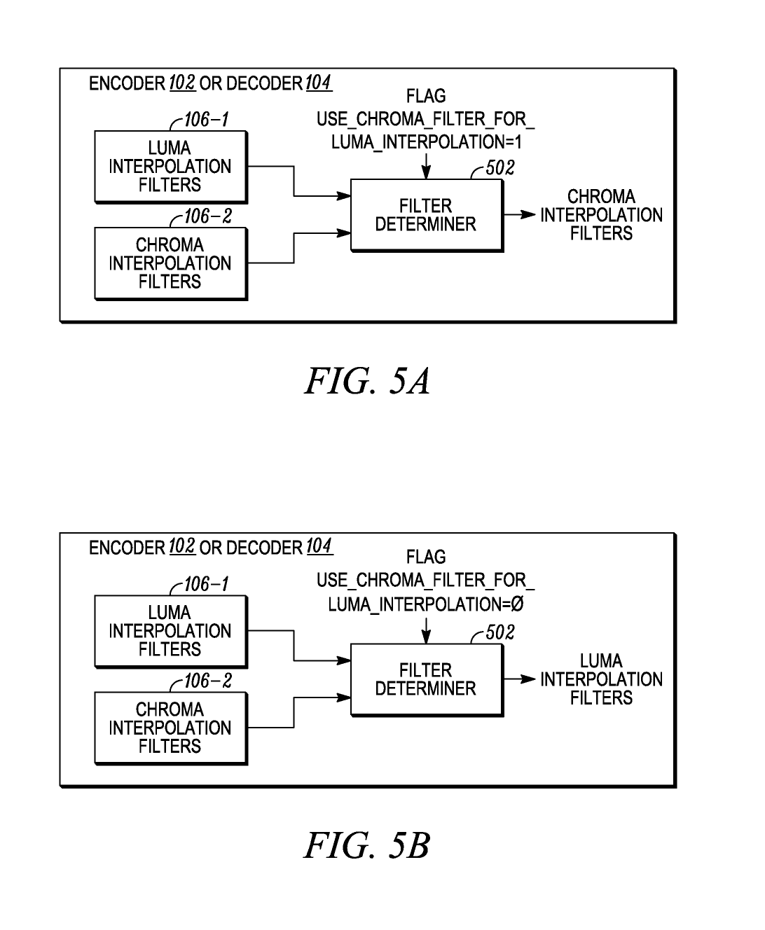

A syntax may be used to indicate the selective use of chroma interpolation filters 106-2 in a luma interpolation process. FIG. 4 depicts an example of a syntax 400 according to one embodiment. Syntax 400 may add syntax (e.g., a flag use_chroma_filter_for_luma_interpolation) at 402 to indicate when a chroma interpolation filter 106-2 should be used in the luma interpolation process. Although the flag use_chroma_filter_for_luma_interpolation is shown, other information may be used to signal that chroma interpolation filters 106-2 should be used in a luma interpolation process. For example, other data structures may be used. Also, it should be noted that although the flag use_chroma_filter_for_luma_interpolation is shown at this position in syntax 400, the flag use_chroma_filter_for_luma_interpolation may be inserted at other positions. Further, the inclusion of the flag use_chroma_filter_for_luma_interpolation may be conditional based on evaluation of a conditional statement that may be based on other syntax or semantics. Thus, the flag use_chroma_filter_for_luma_interpolation may not always be included in the encoded bitstream.

The flag use_chroma_filter_for_luma_interpolation may be added to different portions of an encoded bitstream. For example, the flag use_chroma_filter_for_luma_interpolation may be added to various headers in the encoded bitstream, such as a video parameter set (VPS), a sequence parameter set (SPS), a picture parameter set (PPS), a slice header, or block header (coding tree unit, coding unit, prediction unit, or transform unit). The video parameter set may be the header for the entire video being encoded; the sequence parameter set may be a header for a sequence of pictures; the picture parameter set may be a header for a picture; the slice header may be a header for a slice, which may be one or more blocks in a picture; or the block header may be the header for a specific block.

In one example, the flag use_chroma_filter_for_luma_interpolation may be enabled or disabled. For example, when enabled, the flag use_chroma_filter_for_luma_interpolation is set to a first value, such as 1, and when disabled, the flag use_chroma_filter_for_luma_interpolation is set to a second value, such as 0. When the flag use_chroma_filter_for_luma_interpolation is set to 1, this may indicate that chroma interpolation filters 106-2 may selectively be used in the luma interpolation process. In one embodiment, this may mean a chroma interpolation filter 106-2 is used for all luma interpolation processes for the active portion of video. For example, if the flag use_chroma_filter_for_luma_interpolation is found in the SPS header, then chroma interpolation filters 106-2 are used in all of the pictures in the sequence. In another embodiment, when flag use_chroma_filter_for_luma_interpolation is set to 1, encoder 102 or decoder 104 may selectively use chroma interpolation filters 106-2 in the luma interpolation process. For example, encoder 102 or decoder 104 may interpret characteristics of the video to determine when it is beneficial to use a chroma interpolation filter 106-2 in the luma interpolation process for a sub-pel pixel value.

If the flag use_chroma_filter_for_luma_interpolation is equal to 0, then chroma interpolation filters 106-2 may not be used in the luma interpolation process. That is, luma interpolation filters 106-1 are used in the luma interpolation process.

The following will describe different examples of how the flag use_chroma_filter_for_luma_interpolation may be used. In the first example, when the flag use_chroma_filter_for_luma_interpolation is set to a value of 1, which enables the use of chroma interpolation filters for the luma interpolation process. For example, 4-tap chroma interpolation filters 106-2 are used for the luma interpolation process. Referring to FIG. 2, the half-pel pixel H and the quarter-pel pixels FL and FR between the full-pel pixels L0 and R0 may be determined as follows:

FL=(−4*L1+54*L0+16*R0−2*R1+32)>>6;

H=(−4*L1+36*L0+36*R0−4*R1+32)>>6;

FR=(−2*L1+16*L0+54*R0−4*R1+32)>>6;

Table 3 summarizes the filter coefficients.

TABLE 3
Luma interpolation filter set coefficient

| Position | Coefficients |
|---|---|
| FL | {−4, 54, 16, −2} |
| H | {−4, 36, 36, −4} |
| FR | {−2, 16, 54, −4} |

In the above process, the coefficients for chroma interpolation filter 106-2 that are used are not changed from the coefficients that are used when interpolating the chroma component. For example, encoder 102 and decoder 104 use the coefficients for the FL1, H, and FR1 sub-pel pixel positions in the chroma interpolation filter shown in Table 2 above. However, in certain examples, particular embodiments may use coefficients from different positions, such as FL2 and FR2. Also, in this example, the chroma interpolation filters that are used may include the same number of taps as that used in the chroma interpolation process.

In a second example, the use of chroma interpolation filters 106-2 in the luma interpolation process requires a change of the coefficients in the chroma interpolation filter 106-2. That is, when the flag use_chroma_filter_for_luma_interpolation is set to 1, the same number of taps for the 4-tap chroma interpolation filter 106-2 is used for luma interpolation, but the coefficients may be changed. For example, referring to FIG. 2, the half-pel pixel H and quarter-pel pixels FL and FR between the full-pel pixels L0 and R0 may be determined as follows:

FL=(−4*L1+54*L0+16*R0−2*R1+32)>>6;

H=(−5*L1+37*L0+37*R0−5*R1+32)>>6;

FR=(−2*L1+16*L0+54*R0−4*R1+32)>>6;

Table 4 summarizes the filter coefficients.

TABLE 4
Luma interpolation filter set coefficient

| Position | Coefficients |
|---|---|
| FL | {−4, 54, 16, −2} |
| H | {−5, 37, 37, −5} |
| FR | {−2, 16, 54, −4} |

In the above, the coefficients used in the luma interpolation process for chroma interpolation filter 106-2 may be changed from the coefficients used when the chroma interpolation filters 106-2 are used in the chroma interpolation process. For example, the coefficients for the half-pel pixel H have been changed.

A third example illustrates another use of chroma interpolation filters 106-2 in the luma interpolation process that also changes the chroma interpolation filter coefficients. For example, referring to FIG. 2, the half-pel pixel H and quarter-pel pixels FL and FR between the full-pel pixels L0 and R0 may be determined as follows:

FL=(−4*L1+54*L0+16*R0−2*R1+32)>>6;

H=(−7*L1+39*L0+39*R0−7*R1+32)>>6;

FR=(−2*L1+16*L0+54*R0−4*R1+32)>>6;

Table 5 summarizes the filter coefficients.

TABLE 5
Luma interpolation filter set coefficient

| Position | Coefficients |
|---|---|
| FL | {−4, 54, 16, −2} |
| H | {−7, 39, 39, −7} |
| FR | {−2, 16, 54, −4} |

As above, the coefficients for the half-pel pixel H have been changed.

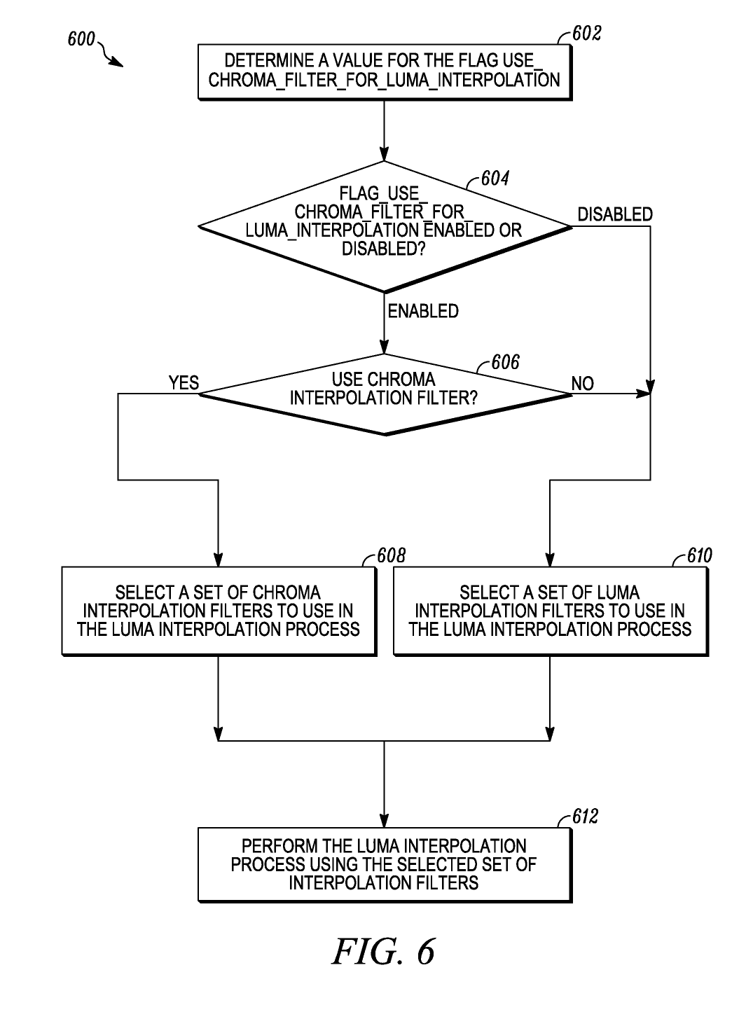

FIG. 5A depicts a more detailed example of encoder 102 or decoder 104 according to one embodiment. A filter determiner 502 determines which interpolation filter 106 to use in a luma interpolation process. For example, filter determiner 502 may determine when to use chroma interpolation filters 106-2 in the luma interpolation process. As discussed above, a flag use_chroma_filter_for_luma_interpolation may be used to indicate when chroma interpolation filters are used in the luma interpolation process. In this case, filter determiner 502 may determine the value of the flag use_chroma_filter_for_luma_interpolation when a portion of video is being encoded or decoded. For example, a sequence parameter set header may include the value for the flag use_chroma_filter_for_luma_interpolation. In this case, for all pictures in an active sequence being encoded or decoded, the flag use_chroma_filter_for_luma_interpolation applies.

In this example, filter determiner 502 determines the value is 1 for the flag use_chroma_filter_for_luma_interpolation, which means that chroma interpolation filters 106-2 should be used in the luma interpolation process. In one example, encoder 502 may have determined that chroma interpolation filters 106-2 should be used in the luma interpolation process and set the value for the flag as 1. Encoder 102 may make this determination based on characteristics of the video being encoded. In another example, decoder 104 may decode the encoded bitstream and determine the value of the flag use_chroma_filter_for_luma_interpolation. As discussed above, chroma interpolation filters 106-2 may always be used in the luma interpolation process or may be selectively used when the flag is 1. In the case shown in FIG. 5A, filter determiner 502 determines that chroma interpolation filter 106-2 should be used and selects which chroma interpolation filters 106-2 to use.

It should be noted that instead of using an explicit process where the flag use_chroma_filter_for_luma_interpolation is used to indicate whether or not chroma interpolation filters 106-2 should be selectively used, implicit methods may be used.

In one embodiment, in the implicit method, encoder 102 does not signal to decoder 104 when chroma interpolation filters 106-2 were used in the luma interpolation process. Rather, encoder 102 and decoder 104 independently determine when chroma interpolation filters 106-2 should be used in the luma interpolation process.

In one embodiment, filter determiner 502 may implicitly determine whether or not to use chroma interpolation filters 106-2 in the luma interpolation process based on certain characteristics in the video. For example, filter determiner 502 may analyze the syntax or characteristics of the video to determine when to use chroma interpolation filters 106-2 in the luma interpolation process. In one example, filter determiner 502 analyzes the video resolution of a picture to determine whether to use chroma interpolation filters 106-2 in the luma interpolation process.

FIG. 5B depicts another example of encoder 102 or decoder 104 for the determination of which interpolation filters to use for the luma interpolation process according to one embodiment. In this case, filter determiner 502 may determine that luma interpolation filters 106-1 are not used in the luma interpolation process. This may occur when the flag use_chroma_filter_for_luma_interpolation is set to 0 to indicate that chroma interpolation filters 106-2 are not used in the luma interpolation process. In this case, filter determiner 502 always determines that luma interpolation filters 106-1 are used in the luma interpolation process.

Although a process that uses chroma interpolation filters 106-2 in the luma interpolation process is described, particular embodiments may also use luma interpolation filters 106-1 in the chroma interpolation process. Further, a third set of interpolation filters may also be used to substitute for luma interpolation filters 106-1. That is, the third type of interpolation filters may be used in the luma interpolation process when the flag use_chroma_filter_for_luma_interpolation is enabled. This may require additional complexity, but the third type of interpolation filters may be better suited for the luma interpolation process.

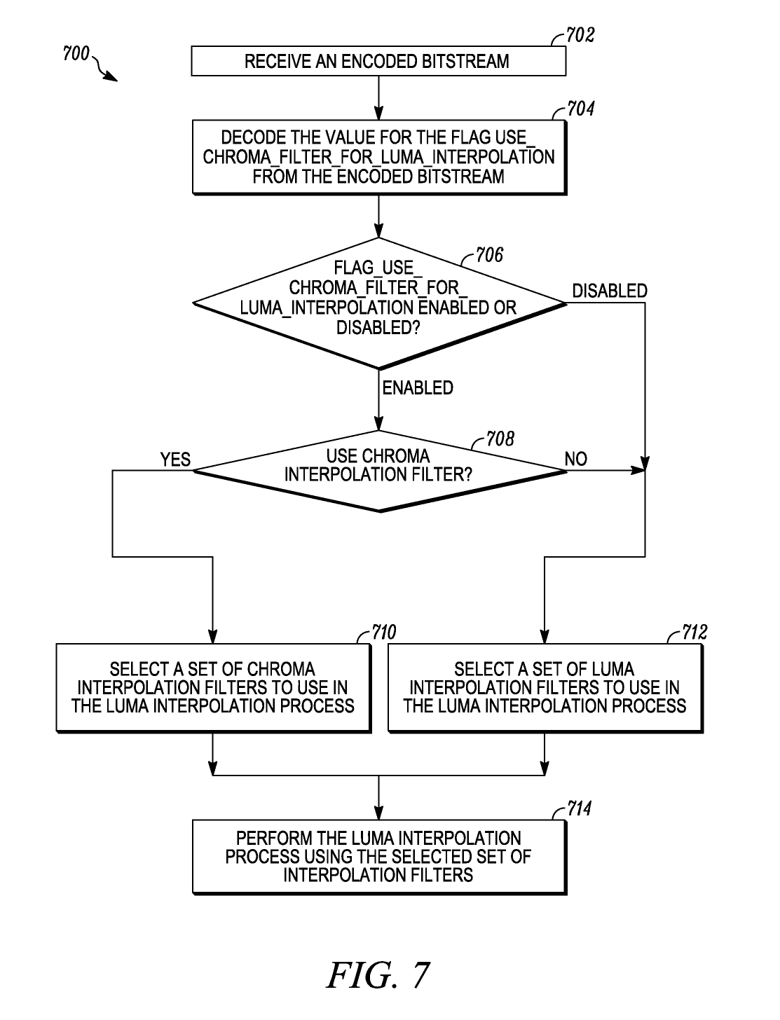

FIG. 6 depicts a simplified flowchart 600 of a method for determining an interpolation filter 106 during an encoding process according to one embodiment. At 602, filter determiner 502 determines a value for the flag use_chroma_filter_for_luma_interpolation. The flag use_chroma_filter_for_luma_interpolation may be associated with an active portion of video. For example, the flag use_chroma_filter_for_luma_interpolation may be included in an SPS header for a sequence of pictures that are actively being encoded. At 604, filter determiner 502 determines if the flag use_chroma_filter_for_luma_interpolation is enabled (e.g., 1) or disabled (e.g., 0).

At 606, if the flag use_chroma_filter_for_luma_interpolation is enabled, filter determiner 502 determines if a chroma interpolation filter 106-2 should be used in the luma interpolation process. For example, as described above, when the flag use_chroma_filter_for_luma_interpolation is enabled, filter determiner 502 may always use chroma interpolation filters 106-2 in the luma interpolation process. In other cases, chroma interpolation filters 106-2 may be selectively used in the luma interpolation process. At 608, if filter determiner 502 determines that chroma interpolation filters 106-2 should be used in the luma interpolation process, filter determiner 502 selects a set of chroma interpolation filters 106-2 to use in the luma interpolation process. For example, different chroma interpolation filters 106-2 may be available. Filter determiner 502 may select a set of the chroma interpolation filters 106-2 with coefficients determined to provide the most efficient compression for sub-pel pixel values for the luma component.

At 610, if filter determiner 502 determines that a chroma interpolation filter 106-2 should not be used in the luma interpolation process, filter determiner 502 selects a set of luma interpolation filters 106-1 to use. Additionally, referring back to 604, if the flag use_chroma_filter_for_luma_interpolation was not enabled, the process at 610 is also performed where filter determiner 502 selects a set of luma interpolation filters 106-1 to use.

At 612, encoder 102 performs the luma interpolation process using the selected set of interpolation filters. For example, either the chroma interpolation filters 106-2 or luma interpolation filters 106-1 are is used to interpolate sub-pel pixel values for the luma component.

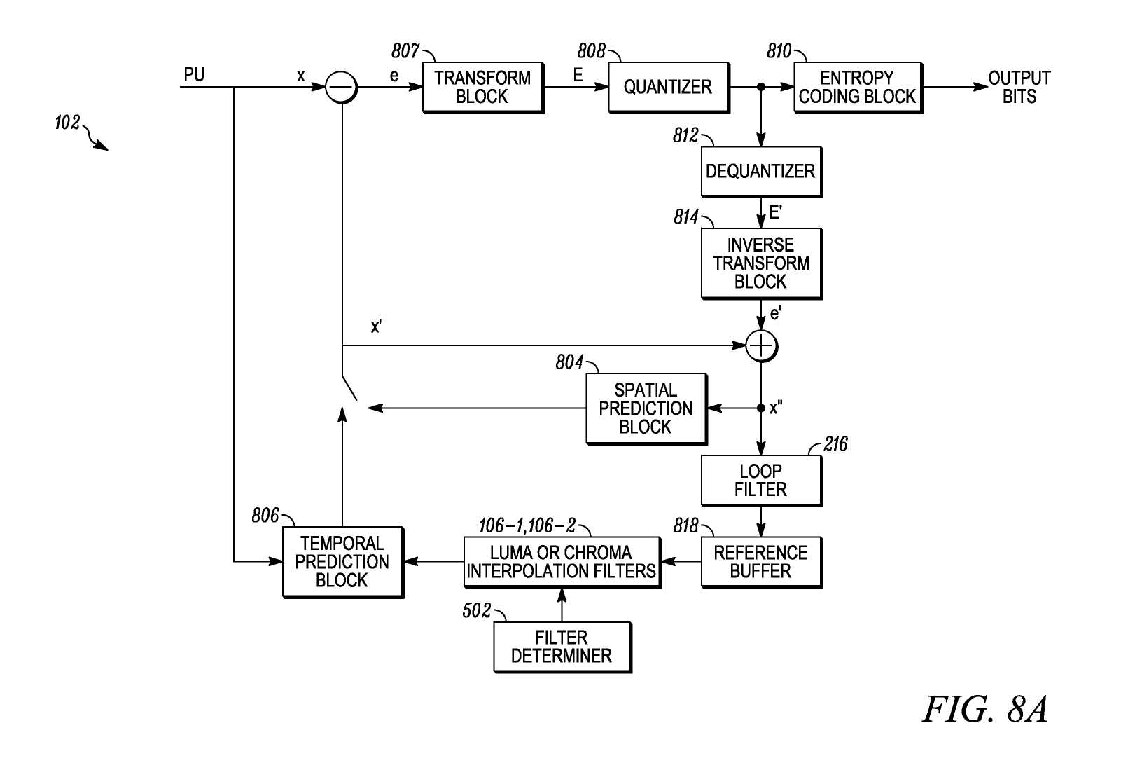

FIG. 7 depicts a simplified flowchart 700 for determining an interpolation filter 106 during a decoding process according to one embodiment. At 702, decoder 104 receives an encoded bitstream. The encoded bitstream may include the flag use_chroma_filter_for_luma_interpolation in one of the headers, such as the SPS header. The SPS header may be applicable for a sequence of pictures that are actively being decoded by decoder 104. In this case, encoder 102 may have set the flag use_chroma_filter_for_luma_interpolation to a value of 1 or 0. At 704, decoder 104 decodes the value for the flag use_chroma_filter_for_luma_interpolation from the encoded bitstream.

At 706, decoder 104 determines if the flag use_chroma_filter_for_luma_interpolation is enabled or disabled. If enabled, at 708, filter determiner 502 determines if chroma interpolation filters 106-2 should be used in the luma interpolation process. As discussed above with respect to the encoding process, filter determiner 502 in decoder 104 may always use chroma interpolation filters 106-2 in the luma interpolation process or may selectively use chroma interpolation filters 106-2 in the luma interpolation process when the flag use_chroma_filter_for_luma_interpolation is enabled. At 708, if filter determiner 502 determines that chroma interpolation filters 106-2 should be used in the luma interpolation process, filter determiner 502 selects a set of chroma interpolation filters 106-2 for use in the luma interpolation process. However, if filter determiner 502 determines that chroma interpolation filters 106-2 should not be used in the luma interpolation process, at 710, filter determiner 502 selects a set of luma interpolation filters 106-1 for use in the luma interpolation process. Also, if the flag use_chroma_filter_for_luma_interpolation was disabled, then the process at 710 is also performed where filter determiner 502 selects a set of luma interpolation filters 106-1 for the luma interpolation process. At 712, decoder 104 performs the luma interpolation process using the selected set of interpolation filters.

The following will describe encoder 102 and decoder 104 examples that may be used with particular embodiments.

### Encoder and Decoder Examples

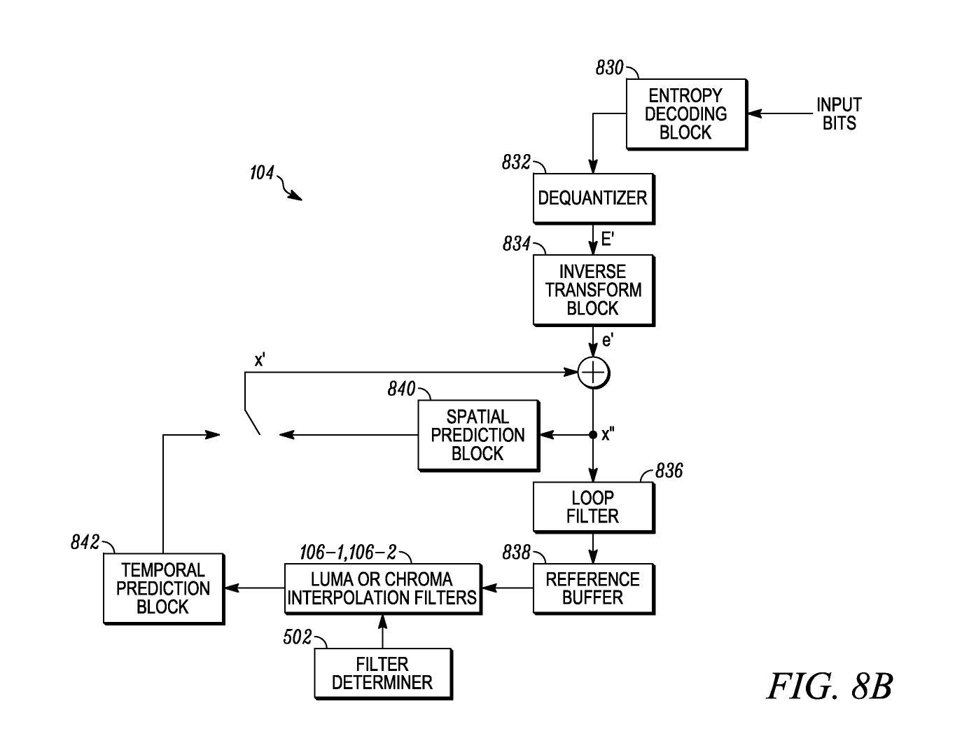

In various embodiments, encoder 102 described can be incorporated or otherwise associated with a transcoder or an encoding apparatus at a headend and decoder 104 can be incorporated or otherwise associated with a downstream device, such as a mobile device, a set top box or a transcoder. FIG. 8A depicts an example of encoder 102 according to one embodiment. A general operation of encoder 102 will now be described; however, it will be understood that variations on the encoding process described will be appreciated by a person skilled in the art based on the disclosure and teachings herein.

For a current PU, x, a prediction PU, x′, is obtained through either spatial prediction or temporal prediction. The prediction PU is then subtracted from the current PU, resulting in a residual PU, e. Spatial prediction relates to intra mode pictures. Intra mode coding can use data from the current input image, without referring to other images, to code an I picture. A spatial prediction block 804 may include different spatial prediction directions per PU, such as horizontal, vertical, 45-degree diagonal, 135-degree diagonal, DC (flat averaging), and planar, or any other direction. The spatial prediction direction for the PU can be coded as a syntax element. In some embodiments, brightness information (Luma) and color information (Chroma) for the PU can be predicted separately. In one embodiment, the number of Luma intra prediction modes for all block sizes is 35. An additional mode can be used for the Chroma intra prediction mode. In some embodiments, the Chroma prediction mode can be called “IntraFromLuma.”

Temporal prediction block 806 performs temporal prediction. Inter mode coding can use data from the current input image and one or more reference images to code “P” pictures and/or “B” pictures. In some situations and/or embodiments, inter mode coding can result in higher compression than intra mode coding. In inter mode PUs can be temporally predictive coded, such that each PU of the CU can have one or more motion vectors and one or more associated reference images. Temporal prediction can be performed through a motion estimation operation that searches for a best match prediction for the PU over the associated reference images. The best match prediction can be described by the motion vectors and associated reference images. P pictures use data from the current input image and one or more reference images, and can have up to one motion vector. B pictures may use data from the current input image and one or more reference images, and can have up to two motion vectors. The motion vectors and reference pictures can be coded in the encoded bitstream. In some embodiments, the motion vectors can be syntax elements “MV,” and the reference pictures can be syntax elements “refldx.” In some embodiments, inter mode can allow both spatial and temporal predictive coding. The best match prediction is described by the motion vector (MV) and associated reference picture index (refldx). The motion vector and associated reference picture index are included in the coded bitstream.

Transform block 807 performs a transform operation with the residual PU, e. A set of block transforms of different sizes can be performed on a CU, such that some PUs can be divided into smaller TUs and other PUs can have TUs the same size as the PU. Division of CUs and PUs into TUs can be shown by a quadtree representation. Transform block 807 outputs the residual PU in a transform domain, E.

A quantizer 808 then quantizes the transform coefficients of the residual PU, E. Quantizer 808 converts the transform coefficients into a finite number of possible values. In some embodiments, this is a lossy operation in which data lost by quantization may not be recoverable. After the transform coefficients have been quantized, entropy coding block 810 entropy encodes the quantized coefficients, which results in final compression bits to be transmitted. Different entropy coding methods may be used, such as context-adaptive variable length coding (CAVLC) or context-adaptive binary arithmetic coding (CABAC).

Also, in a decoding process within encoder 102, a de-quantizer 812 de-quantizes the quantized transform coefficients of the residual PU. De-quantizer 812 then outputs the de-quantized transform coefficients of the residual PU, E′. An inverse transform block 814 receives the de-quantized transform coefficients, which are then inverse transformed resulting in a reconstructed residual PU, e′. The reconstructed PU, e′, is then added to the corresponding prediction, x′, either spatial or temporal, to form the new reconstructed PU, x″. Particular embodiments may be used in determining the prediction, such as collocated reference picture manager 404 is used in the prediction process to determine the collocated reference picture to use. A loop filter 816 performs de-blocking on the reconstructed PU, x″, to reduce blocking artifacts. Additionally, loop filter 816 may perform a sample adaptive offset process after the completion of the de-blocking filter process for the decoded picture, which compensates for a pixel value offset between reconstructed pixels and original pixels. Also, loop filter 816 may perform adaptive loop filtering over the reconstructed PU, which minimizes coding distortion between the input and output pictures. Additionally, if the reconstructed pictures are reference pictures, the reference pictures are stored in a reference buffer 818 for future temporal prediction. Intra mode coded images can be a possible point where decoding can begin without needing additional reconstructed images.

Luma interpolation filters 106-1 and chroma interpolation filters 106-2 interpolate sub-pel pixel values for temporal prediction block 206. Also, filter determiner 502 may determine a set of luma interpolation filters 106-1 or chroma interpolation filters 106-2 to use. Temporal prediction block 206 then uses the sub-pel pixel values outputted by either luma interpolation filters 106-1 or chroma interpolation filters 106-2 to generate a prediction of a current PU.

FIG. 8B depicts an example of decoder 104 according to one embodiment. A general operation of decoder 104 will now be described; however, it will be understood that variations on the decoding process described will be appreciated by a person skilled in the art based on the disclosure and teachings herein. Decoder 104 receives input bits from encoder 102 for encoded video content.

An entropy decoding block 830 performs entropy decoding on the input bitstream to generate quantized transform coefficients of a residual PU. A de-quantizer 832 de-quantizes the quantized transform coefficients of the residual PU. De-quantizer 832 then outputs the de-quantized transform coefficients of the residual PU, E′. An inverse transform block 834 receives the de-quantized transform coefficients, which are then inverse transformed resulting in a reconstructed residual PU, e′.

The reconstructed PU, e′, is then added to the corresponding prediction, x′, either spatial or temporal, to form the new reconstructed PU, x″. A loop filter 836 performs de-blocking on the reconstructed PU, x″, to reduce blocking artifacts. Additionally, loop filter 836 may perform a sample adaptive offset process after the completion of the de-blocking filter process for the decoded picture, which compensates for a pixel value offset between reconstructed pixels and original pixels. Also, loop filter 836 may perform adaptive loop filtering over the reconstructed PU, which minimizes coding distortion between the input and output pictures. Additionally, if the reconstructed pictures are reference pictures, the reference pictures are stored in a reference buffer 838 for future temporal prediction.

The prediction PU, x′, is obtained through either spatial prediction or temporal prediction. A spatial prediction block 840 may receive decoded spatial prediction directions per PU, such as horizontal, vertical, 45-degree diagonal, 135-degree diagonal, DC (flat averaging), and planar. The spatial prediction directions are used to determine the prediction PU, x′.

A temporal prediction block 806 performs temporal prediction through a motion estimation operation. A decoded motion vector is used to determine the prediction PU, x′. Interpolation may be used in the motion estimation operation.

Luma interpolation filters 106-1 and chroma interpolation filters 106-2 interpolate sub-pel pixel values for input into a temporal prediction block 242. Also, filter determiner 502 may determine a set of luma interpolation filters 106-1 or chroma interpolation filters 106-2 to use. Temporal prediction block 806 performs temporal prediction using decoded motion vector information and interpolated sub-pel pixel values outputted by luma interpolation filters 106-1 or chroma interpolation filters 106-2 in a motion compensation operation. Temporal prediction block 806 outputs the prediction PU, x′.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining one or more luma interpolation filters for interpolating sub-pel pixel values for a luma component, the one or more luma interpolation filters having a first number of coefficients;
determining one or more chroma interpolation filters for interpolating sub-pel pixel values for a chroma component, the one or more chroma interpolation filters having a second number of coefficients, wherein the second number of coefficients is less than the first number of coefficients;
determining when the one or more chroma interpolation filters should be used to interpolate a sub-pel pixel value for the luma component; and
when the one or more chroma interpolation filters should be used to interpolate the sub-pixel value for the luma component, using a chroma interpolation filter to interpolate a sub-pixel value for the luma component by applying coefficients of the chroma interpolation filter to corresponding pixel values for the luma component.

2. The method of claim 1, wherein determining when the one or more chroma interpolation filters should be used to interpolate the sub-pixel value for the luma component comprises:
determining if a flag is set to a value indicating that chroma interpolation filters should be used to interpolate sub-pel pixel values for the luma component.

3. The method of claim 2, wherein the flag is associated with a portion of video including the luma component.

4. The method of claim 3, wherein the value for the flag is included in a header in an encoded bitstream associated with the portion of video.

5. The method of claim 3, wherein the value for the flag is decoded from an encoded bitstream associated with the portion of video.

6. The method of claim 3, wherein the value for the flag is encoded in an encoded bitstream associated with the portion of video.

7. The method of claim 1, wherein determining when the one or more chroma interpolation filters should be used to interpolate the sub-pel pixel value for the luma component comprises:
selectively determining when to the use the chroma interpolation filter to interpolate the sub-pel pixel value for the luma component.

8. The method of claim 1, further comprising using a set of chroma interpolation filters to interpolate a set of sub-pixel values for the luma component when the one or more chroma interpolation filters should be used to interpolate the set of sub-pixel values for the luma component.

9. The method of claim 1, wherein when the one or more chroma interpolation filters should not be used to interpolate the sub-pixel value for the luma component, the method further comprising:
using a luma interpolation filter in the one or more luma interpolation filters to interpolate the sub-pel pixel value for the luma component by applying coefficients to corresponding pixel values for the luma component.

10. The method of claim 9, wherein when the one or more chroma interpolation filters for the chroma component should not be used to interpolate the sub-pixel value for the luma component, a flag is set to a value indicating that chroma interpolation filters should not be used to interpolate sub-pixel values for the luma component.

11. The method of claim 1, wherein determining when the one or more chroma interpolation filters should be used to interpolate the sub-pixel value for the luma component comprises:
implicitly determining that chroma interpolation filters for the chroma component should be used to interpolate the sub-pixel value for the luma component based on characteristics of the video.

12. The method of claim 11, wherein implicitly determining comprises not communicating whether chroma interpolation filters should be used to interpolate the sub-pixel value for the luma component between an encoder and a decoder.

13. An encoder comprising:
one or more computer processors; and
a non-transitory computer-readable storage medium comprising instructions, that when executed, control the one or more computer processors to be configured for:
determining one or more luma interpolation filters for interpolating sub-pel pixel values for a luma component, the one or more luma interpolation filters having a first number of coefficients;
determining one or more chroma interpolation filters for interpolating sub-pel pixel values for a chroma component, the one or more chroma interpolation filters having a second number of coefficients, wherein the second number of coefficients is less than the first number of coefficients;
determining when the one or more chroma interpolation filters should be used to interpolate a sub-pel pixel value for the luma component; and
when the one or more chroma interpolation filters should be used to interpolate the sub-pixel value for the luma component, using a chroma interpolation filter to interpolate a sub-pixel value for the luma component by applying coefficients of the chroma interpolation filter to corresponding pixel values for the luma component; and
encoding a unit of video using the sub-pel pixel value for the luma component.

14. The encoder of claim 13, wherein determining when the one or more chroma interpolation filters should be used to interpolate the sub-pixel value for the luma component comprises:
determining if a flag is set to a value indicating that chroma interpolation filters should be used to interpolate sub-pel pixel values for the luma component.

15. The encoder of claim 14, further comprising encoding the value for the flag in a header in an encoded bitstream associated with a portion of video including the luma component.

16. The encoder of claim 13, wherein determining when the one or more chroma interpolation filters should be used to interpolate the sub-pel pixel value for the luma component comprises:
selectively determining when to the use the chroma interpolation filter to interpolate the sub-pel pixel value for the luma component.

17. A decoder comprising:
one or more computer processors; and
a non-transitory computer-readable storage medium comprising instructions, that when executed, control the one or more computer processors to be configured for:
receiving an encoded bitstream;
determining one or more luma interpolation filters for interpolating sub-pel pixel values for a luma component, the one or more luma interpolation filters having a first number of coefficients;
determining one or more chroma interpolation filters for interpolating sub-pel pixel values for a chroma component, the one or more chroma interpolation filters having a second number of coefficients, wherein the second number of coefficients is less than the first number of coefficients;
determining when the one or more chroma interpolation filters should be used to interpolate a sub-pel pixel value for the luma component;
when the one or more chroma interpolation filters should be used to interpolate the sub-pixel value for the luma component, using a chroma interpolation filter to interpolate a sub-pixel value for the luma component by applying coefficients of the chroma interpolation filter to corresponding pixel values for the luma component; and
decoding a unit of video in the encoded bitstream using the sub-pel pixel value for the luma component.

18. The decoder of claim 17, wherein determining when the one or more chroma interpolation filters should be used to interpolate the sub-pixel value for the luma component comprises:
determining if a flag is set to a value indicating that chroma interpolation filters should be used to interpolate sub-pel pixel values for the luma component.

19. The decoder of claim 18, further comprising decoding the value for the flag from the encoded bitstream associated with a portion of video including the luma component.

20. The decoder of claim 17, wherein determining when the one or more chroma interpolation filters should be used to interpolate the sub-pel pixel value for the luma component comprises:
selectively determining when to the use the chroma interpolation filter to interpolate the sub-pel pixel value for the luma component.
